(19) United States
(12) Patent Application Publication
(10) Pub. No.: US 2014/0103762 A1
(43) Pub. Date: Apr. 17, 2014

(54) THREADED ROD RECIPROCATION OUTER ROTOR DIRECT DRIVE MECHANISM

(71) Applicant: HIWIN MIKROSYSTEM CORP., Taichung City (TW)

(72) Inventor: Yung-Tsai CHUO, TAICHUNG CITY (TW)

(73) Assignee: HIWIN MIKROSYSTEM CORP., TAICHUNG CITY (TW)

(21) Appl. No.: 13/672,215

(22) Filed: Nov. 8, 2012

(30) Foreign Application Priority Data
Oct. 17, 2012 (TW) 101138170

(51) Int. Cl. H02K 7/06

(52) U.S. Cl. CPC H02K 7/06
USPC 310/80

(57) ABSTRACT

A threaded rod reciprocation outer rotor direct drive mechanism is provided. A threaded rod is coaxially screwed in a threaded bush. The threaded bush directly serves as the rotor of the outer rotor torque motor. Accordingly, the blind spot of the conventional technique is overcome to reduce the number of the components and minify the total volume and simplify the assembling and processing procedure.

### BACKGROUND OF THE INVENTION

1. Field of the Invention

The present invention relates generally to a transmission technique, and more particularly to a threaded rod reciprocation outer rotor direct drive mechanism.

2. Description of the Related Art

It is known that a motor can be used to drive a threaded rod to linearly reciprocally move. A proper transmission component is disposed between the output shaft of the motor and a threaded bush, whereby the power of the motor is indirectly transmitted to the threaded bush for rotating the threaded bush. At this time, the threaded rod coaxially screwed in the threaded bush is linearly reciprocally moved.

FIG. 1 shows a conventional threaded rod reciprocation mechanism. The motor 1 has a tubular rotor 2, which is drivingly connected to a threaded bush 4 via a gear section 3. When the rotor 2 rotates, the threaded bush 4 is driven by the rotor 2 via the gear section 3 to synchronously rotate. At this time, the threaded rod 5 coaxially screwed in the threaded bush 4 is linearly reciprocally moved.

FIG. 2 shows another conventional threaded rod reciprocation mechanism free from the gear section. In this threaded rod reciprocation mechanism, a threaded bush 6 is directly coaxially fixedly connected with one end of a tubular rotor 7 by means of a fixing structure. When the rotor 7 rotates, through the fixing structure, the threaded bush 6 is driven by the rotor 7 to synchronously rotate. At this time, the threaded rod 8 coaxially screwed in the threaded bush 6 is linearly reciprocally moved.

In comparison with the traditional threaded rod reciprocation mechanism in which the threaded bush is indirectly driven to linearly reciprocally move via an external reducing gear set, in the above threaded rod reciprocation mechanism, the threaded rod is coupled with the motor without using any external reducing gear set. Therefore, the total volume is minified and the transmission loss is reduced. However, in the conventional technique, there is a technical blind spot that the threaded bush and the threaded rod are always treated as a set of components. That is, the threaded bush is still treated as a component independent from the motor. Under this technical blind spot, the threaded bush is always indirectly driven by the motor to rotate for linearly reciprocally moving the threaded rod. No matter whether the threaded bush is connected to the rotor of the motor via a gear or is serially connected to the rotor of the motor, the number of the components is increased. As a result, the assembling and processing procedure is complicated to lead to increase of manufacturing cost.

### SUMMARY OF THE INVENTION

It is therefore a primary object of the present invention to provide a threaded rod reciprocation outer rotor direct drive mechanism is provided. A threaded rod is coaxially screwed in a threaded bush. The threaded bush directly serves as the rotor of the outer rotor torque motor. Accordingly, the blind spot of the conventional technique is overcome to reduce the number of the components and minify the total volume and simplify the assembling and processing procedure.

To achieve the above and other objects, the threaded rod reciprocation outer rotor direct drive mechanism of the present invention includes: an outer rotor torque motor including a stator section and a rotor section annularly disposed around the stator section; and a threaded rod set including a tubular threaded bush and a threaded rod coaxially screwed in the threaded bush. The threaded rod reciprocation outer rotor direct drive mechanism is characterized in that the stator section has an annular form and the threaded rod coaxially extends through into the stator section. The threaded bush has a tubular shaft body coaxially positioned around outer circumference of the stator section. The threaded bush further has a threaded hub section coaxially positioned at an axial end of the shaft body. Apart of the threaded rod, which part extends out of the stator section, is screwed in the threaded hub section. Multiple magnets of the rotor section are fixedly attached to inner circumference of the shaft body. The magnets face the outer circumference of the stator section and are spaced from the outer circumference of the stator section.

In the above threaded rod reciprocation outer rotor direct drive mechanism, the threaded rod is an Acme thread rod or a ball threaded rod.

The above threaded rod reciprocation outer rotor direct drive mechanism further includes an angle analysis device for providing information of rotational angle.

In the above threaded rod reciprocation outer rotor direct drive mechanism, the shaft body has an inner diameter larger than that of the threaded hub section and an annular shoulder section is defined between the threaded hub section and the shaft body. The shoulder section is spaced from an axial end face of the stator section. The angle analysis device is disposed in a space defined between the shoulder section and the axial end face of the stator section.

The present invention can be best understood through the following description and accompanying drawings, wherein:

### BRIEF DESCRIPTION OF THE DRAWINGS

FIG. 1 is a sectional view of a conventional threaded rod reciprocation mechanism;

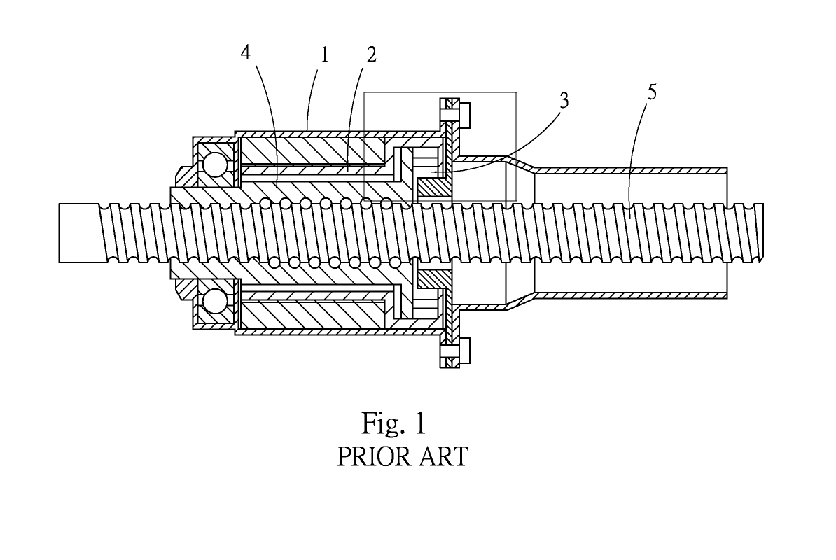

FIG. 2 is a sectional view of another conventional threaded rod reciprocation mechanism;

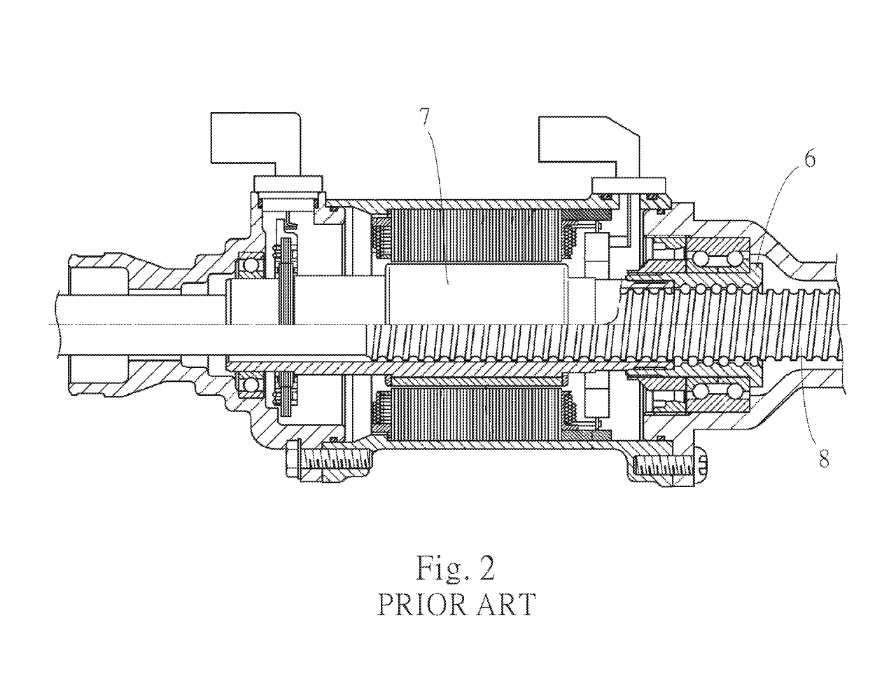

FIG. 3 is a perspective assembled view of a preferred embodiment of the present invention; and

FIG. 4 is a sectional assembled view of the preferred embodiment of the present invention.

### DETAILED DESCRIPTION OF THE PREFERRED EMBODIMENTS

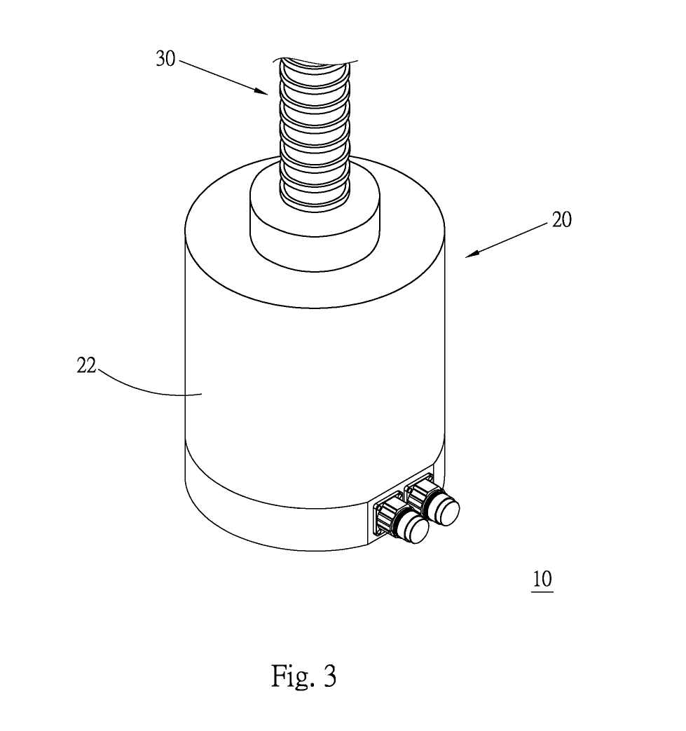

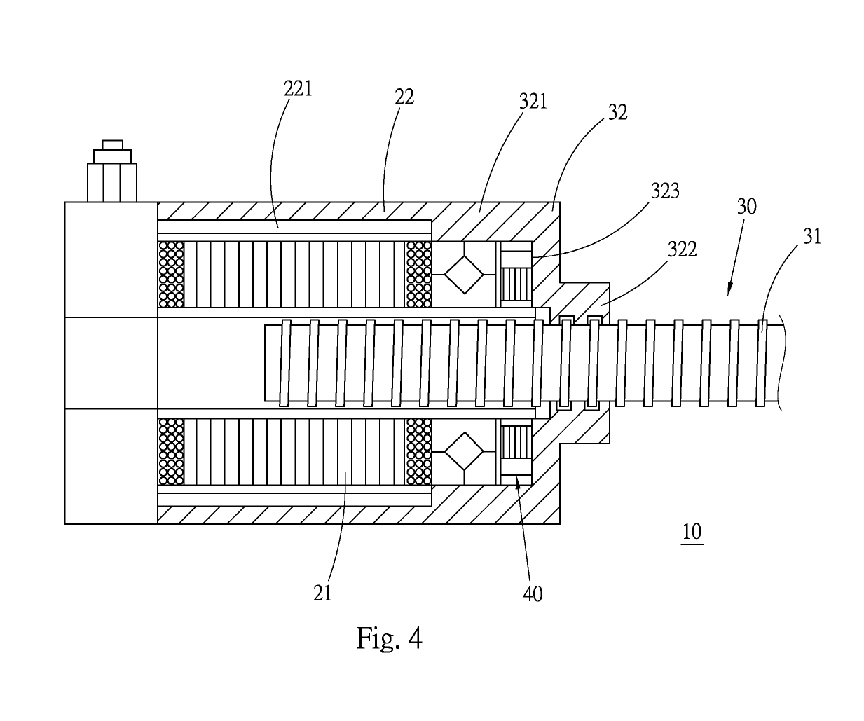

Please refer to FIGS. 3 and 4. According to a preferred embodiment, the threaded rod reciprocation outer rotor direct drive mechanism 10 of the present invention includes an outer rotor torque motor 20, a threaded rod set 30 and an angle analysis device 40.

The outer rotor torque motor 20 includes a tubular stator section 21 having windings and a rotor section 22 annularly disposed around the stator section 21. After powered on, the windings of the stator section 21 create varying magnetic field. The rotor section 22 has multiple magnets 221 for creating fixed magnetic field.

In this embodiment, the threaded rod set 30 is, but not limited to, an Acme threaded rod. Alternatively, the threaded rod set 30 can be a conventional ball threaded rod. To speak more specifically, the threaded rod set 30 includes a threaded rod 31 with a certain length and a threaded bush 32 coaxially screwed on the threaded rod 31.

In this embodiment, the angle analysis device 40 is a conventional resolver.

The present invention is mainly characterized in that the threaded rod set 30 and the outer rotor torque motor 20 have a common component. That is, in the present invention, the threaded rod set 30 is changed from a passive state to an active state. To speak more specifically, the present invention is characterized in that the stator section 21 has an annular form. The windings are wound on the outer circumference of the stator section 21 by means of an automatic winding apparatus. The threaded rod 31 coaxially extends into the stator section 21.

The threaded bush 32 has a tubular shaft body 321 with a certain inner diameter. The shaft body 321 is coaxially positioned around the outer circumference of the stator section 21. The threaded bush 32 further has a threaded hub section 32 with an inner diameter smaller than that of the shaft body 321. The threaded hub section 322 is coaxially positioned at an axial end of the shaft body 321. An annular shoulder section 323 is defined between the threaded hub section 322 and the shaft body 321. The shoulder section 323 is spaced from an axial end face of the stator section 21. The angle analysis device 40 is disposed in a space between the shoulder section 323 and the axial end face of the stator section 21. Preferably, the components of the threaded bush 32 are integrally formed with each other.

The magnets 221 of the rotor section 22 are sequentially fixedly attached to the inner circumference of the shaft body 321. The magnets 221 face the stator section 21 and are spaced from the stator section 21. According to the above arrangement, the threaded bush 32 not only is a part of the threaded rod set 30, but also serves as a part of the torque motor 20. In this case, the shaft body 321 directly serves as a rotary shaft of the rotor section 22 so that the threaded bush 32 is directly driven to rotate for driving the threaded rod 31 to axially linearly reciprocally move.

In comparison with the conventional technique, in the threaded rod reciprocation outer rotor direct drive mechanism 10 of the present invention, the number of the components is reduced. Moreover, by means of the direct drive technique, the assembling and processing time is shortened. Also, with respect to the outer rotor electrical structure, the windings can be wound by means of an automatic winding apparatus without using labor to ensure good quality of the products. In addition, the angle analysis device serves to provide position feedback signal. This is helpful in application of the products to those fields requiring higher precision, for example, a vehicle power steering system. The threaded rod reciprocation outer rotor direct drive mechanism 10 of the present invention is also applicable to the automation industry necessitating linear operation.

The above embodiments are only used to illustrate the present invention, not intended to limit the scope thereof. Many modifications of the above embodiments can be made without departing from the spirit of the present invention.

What is claimed is:

1. A threaded rod reciprocation outer rotor direct drive mechanism comprising:
an outer rotor torque motor including a stator section and a rotor section annularly disposed around the stator section; and
a threaded rod set including a tubular threaded bush and a threaded rod coaxially screwed in the threaded bush, the threaded rod reciprocation outer rotor direct drive mechanism being characterized in that the stator section has an annular form and the threaded rod coaxially extends through into the stator section, the threaded bush having a tubular shaft body coaxially positioned around outer circumference of the stator section, the threaded bush further having a threaded hub section coaxially positioned at an axial end of the shaft body, a part of the threaded rod, which part extends out of the stator section, being screwed in the threaded hub section, multiple magnets of the rotor section being fixedly attached to inner circumference of the shaft body, the magnets facing the outer circumference of the stator section and being spaced from the outer circumference of the stator section.

2. The threaded rod reciprocation outer rotor direct drive mechanism as claimed in claim 1, wherein the threaded rod is an Acme thread rod.

3. The threaded rod reciprocation outer rotor direct drive mechanism as claimed in claim 1, wherein the threaded rod is a ball threaded rod.

4. The threaded rod reciprocation outer rotor direct drive mechanism as claimed in claim 1, wherein the shaft body has an inner diameter larger than that of the threaded hub section, an annular shoulder section being defined between the threaded hub section and the shaft body, the shoulder section being spaced from an axial end face of the stator section.

5. The threaded rod reciprocation outer rotor direct drive mechanism as claimed in claim 4, further comprising an angle analysis device disposed between the shoulder section and the axial end face of the stator section.
